(19) United States
(12) Patent Application Publication
(10) Pub. No.: US 2011/0087861 A1
(43) Pub. Date: Apr. 14, 2011

(54) System for High-Efficiency Post-Silicon Verification of a Processor

(75) Inventors: Valeria Bertacco, Ann Arbor, MI (US); Ilya Wagner, Hillsboro, OR (US)

(73) Assignee: THE REGENTS OF THE UNIVERSITY OF MICHIGAN, Ann Arbor, MI (US)

(21) Appl. No.: 12/902,891

(22) Filed: Oct. 12, 2010

Related U.S. Application Data
(60) Provisional application No. 61/250,746, filed on Oct. 12, 2009.

(51) Int. Cl. G06F 9/302

(52) U.S. Cl. 712/202; 712/E09.017

(57) ABSTRACT

A post-silicon validation technique is able to craft randomized executable code, with known final outcomes, as a verification test that is executable on a hardware, such as a prototype microprocessor. A verification device is able to generate the test, in the form of programs, in such a way that at the end of the execution, the initial state of the test hardware is restored. Therefore, the final state of such a reversible program is known a priori. The technique may use a program generation algorithm, agnostic to any particular instruction set on the test hardware. In some examples, that algorithm is executed on the test hardware to generate the verification test, which is then executed on that test hardware. In other examples, the verification test is generated on another processor coupled to the test hardware. In either case, the verification test may contain initial and inverse operations determined from the test hardware.

### STATEMENT OF GOVERNMENT INTEREST

This invention was made with government support under contract HR0011-04-3-0002 awarded by the Defense Advanced Research Projects Agency. The government has certain rights in the invention

### BACKGROUND OF THE DISCLOSURE

1. Field of the Disclosure

The disclosure relates generally to post-silicon processor validation and, more particularly, to a test generation framework capable of testing of silicon prototypes and providing an intrinsic mechanism to check the correctness of a test output.

2. Brief Description of Related Technology

Verification remains an unavoidable, yet quite challenging and time-consuming aspect of the microprocessor design and fabrication process. With shortening product timelines and increasing time-to-market pressure, processor manufacturing houses are forced to pour more and more resources into verification. The problem is exacerbated by the appearance and growing adoption of multi-core chips. The design effort in these systems is lower than that of a single-core chip of a similar size, since cores are replicated from a single design. The verification effort is however, higher, because in addition to validating the cores, inter-core communication must also be verified. Therefore, with processor complexity increasing rapidly, and verification speeds lagging behind, bugs, such as the AMD Opteron REP MOVS error and functional problems in the Intel's Core 2 Duo, continue to slip into production silicon.

Hardware verification can be divided into two phases: pre- and post-silicon. Pre-silicon verification employs two major families of solutions: simulation-based tools and formal techniques. Although formal techniques can be used to prove key design properties, such as absence of deadlock, proper ALU (arithmetic logic unit) and FPU (floating-point unit) functionality, etc., these formal techniques suffer from the state explosion problem and can ultimately be used only on small design modules. For example, in the verification of the Intel Pentium 4 processor, formal methods were used only on floating-point units, schedulers and instruction decoders. Simulation-based approaches, on the other hand, do not have such strict limitations, but neither can it provide hard guarantees of correctness: only those behaviors that have occurred during the simulation can be validated. Nevertheless, simulation remains the method of choice for pre-silicon verification due to its scalability.

Post-silicon validation relies on a concept similar to simulation: the hardware prototype executes as many randomly generated input vectors as possible. However, there are a few key differences between this approach and pre-silicon validation. First, the execution on a hardware prototype is several orders of magnitude faster than any functional simulator, therefore, significantly more test vectors can be checked. However, this high speed comes at the price of limited observability: the internal state of the prototype cannot be easily or fully observed, forcing the engineers to diagnose errors from the architectural state of the system. Tests in the post-silicon domain consists of directed tests checking specific features of the processor, compatibility checks, such as operating system boot-up and tests with legacy software, as well as automatically generated random tests. Due to the unpredictable outcome of these random programs, engineers must simulate them on a known-correct model of the design to obtain the correct final state of the hardware prototype to identify discrepancies potentially revealing a bug. While tests can be run at-speed on the hardware, test generation and simulation constitute the bottleneck in this process, limiting it to the performance level of pre-silicon simulation. Consequently, design houses are forced to spend enormous computational resources on test generation and simulation servers.

Traditional post-silicon testing solutions differ from validation in that they rely on a structural model of the design to determine the correct behavior of the silicon part under test and detect electrical and manufacturing defects. However, functional errors in the design will be present in both the hardware prototype and the structural model generated from the register-transfer level (RTL), thus testing is not viable to find this kind of bugs.

Hardware verification with constrained-random test generation has been a focus of both academic and industrial research for a long time. Most efforts, however, have been dedicated to the pre-silicon verification domain, where test length is relatively short compared to real-life applications. One of the most prominent industry tools in this family is Genesys-Pro developed by IBM. This tool provides advanced capabilities for test generation (biasing primitives, templated specification language, etc.) However, it is designed primarily as a pre-silicon tool. Genesys is not capable of producing tests with known final states, and hence its use in the context of post-silicon validation would require a simulator to compute such states. Several other industrial solutions provide similar features, but again require a simulator to generate the final processor state.

As reported by H. Rotithor, Post-silicon validation methodology for microprocessors. IEEE Design & Test of Computers, 17(4):77-88, October 2000, test generation engines targeting the post-silicon domain share some of their properties with the tools mentioned above: test scenarios have a templated format allowing for fast generation of randomized programs. Note however, that the setup described by Rotithor calls for a number of servers to build the tests and known, correct design models to simulate these tests and obtain the correct final state, which will be compared with the results of the prototype execution. Therefore, the Rotithor framework still requires a simulation-based checker in order to expose bugs, unless they manifest themselves more explicitly, e.g., as a deadlock or early test termination.

There also exists a variety of testing solutions that combine ATPG (automatic test patter generation) with techniques for silicon state acquisition such as scan, JTAG, cycle breakpoint or on-chip-logic analyzers. These ATPG approaches are only capable of exposing electrical and manufacturing defects. A functional error, on the other hand, cannot be flagged by these solutions, since it is present not only in the hardware under test, but in the structural model used by the test generator as well.

Finally, R. Raina and R. Molyneaux, Random self-test method—applications on PowerPC microprocessor caches. In Proceedings of the Great Lakes Symposium on VLSI, February 1998 show a solution based on the use of instructions and their inverses for processor verification. However, the work used the reversibility scheme for cache verification, rather than for processor cores.

There is a need for a solution that relies on a functional, high-level specification of the hardware to expose design defects during post-silicon validation.

### SUMMARY OF THE DISCLOSURE

The present application introduces a high-throughput, post-silicon validation methodology that approaches the performance of execution of the raw silicon prototype. By cleverly crafting randomized tests with known final outcome, we address the bottleneck of the traditional post-silicon flow, while leveraging its high design coverage.

This methodology is implemented through a novel test generation framework, which the inventors' have called Reversi, for convenience purposes. The framework provides for post-silicon processor validation, with the preferred goal of exploiting the full performance potential of silicon prototypes and eliminating the costly simulation step required to obtain a known-correct final state. To this end, the Reversi framework is able to generate tests in such a way that at the end of the execution, the initial state of the machine is restored. Therefore, the final state of such a reversible program is known a priori and, the simulation phase of the validation process is bypassed. The framework may use a program generation algorithm that is agnostic to any particular instruction set, thereby allowing it to be easily ported between processors with different instruction and feature sets. Moreover, by removing the simulation step, the developed framework allows for tests to be generated directly by hardware residing on the same system board as the prototype, eliminating the need for costly test generation servers. Consequently, validation speed becomes only limited by the speed of communication between the prototype and the testing board. Moreover, once the system under test is sufficiently validated, the test generator can run directly on it. In this latter case, tests can be produced in one portion of the chip's cores and transferred to other cores for execution. If the generator cores were flawed, they would not produce proper reversible programs, exposing the issue.

We evaluated the framework against a traditional post-silicon validation flow based on a constrained-random test generator paired with an architectural simulator. The experimental results demonstrate that reversible programs can expose more complex processor bugs faster than traditional methods and, at the same time, boost the performance of the testing process by 20 times.

In accordance with one aspect of the disclosure, a method of developing an executable verification test for examining a processor, comprises: identifying one or more initial operations from one or more instructions of the instruction set architecture (ISA) of the processor; determining one or more inverse operations, each corresponding to one of the initial operations; and generating a verification test comprising one or more stacks, wherein each stack is assigned to alter a register on the processor, and each stack is assigned to a different pair of initial operations and inverse operations, wherein if there are a plurality of stacks the stacks are interleaved with each other, further whereby each stacks applies its initial operation to its register and then applies its inverse operation in the reverse order to its register, wherein the application of the inverse operation returns the register to a state before application of the initial operation of the stack.

### BRIEF DESCRIPTION OF THE DRAWING FIGURES

For a more complete understanding of the disclosure, reference should be made to the following detailed description and accompanying drawing figures, in which like reference numerals identify like elements in the figures, and in which:

FIGS. 1a and 1b illustrate of a typical post-silicon validation flow versus a Reversi-based flow as in accord with examples here. FIG. 1a illustrates a typical post-silicon methodology, in which random tests are produced by a test generator and fed to both a golden model simulator and a silicon prototype. Bugs are flagged by differences between the prototype's and simulator's final states. Both test generation and simulation are done on a host machine at relatively slow speed. FIG. 1b illustrates a Reversi-based flow in accordance with an example and that does not require a simulator. Instead, random reversible programs are generated on a tester board or on the hardware prototype itself. Bugs are flagged by differences between final and initial states of the prototype.

FIG. 2 illustrates prototype structures used to generate tests including load and store instructions, where load/store pairs are used to copy bytes from source to destination data structures. Bytes may be reshuffled, but their exclusive OR hash must match.

FIGS. 3a and 3b illustrate prototype structures used to generate tests including branch operations. FIG. 3a illustrates a block pair for a forward taken branch. The operation block includes a modifying load, a branch and the return label, while the inverse block contains a restoring load and a return jump. FIG. 3b illustrates a structure of a forward not-taken branch. The dashed line indicates the program flow for a case when the branch is taken by the faulty hardware.

FIGS. 4a and 4b illustrate prototype structures used to generate tests including instructions affecting control flags. FIG. 4a illustrates a block pair for testing mode control registers. An erroneous register operation is reflected in the focus register's value. FIG. 4b illustrates a block pair for instructions affecting execution flag registers. The operation block includes an arithmetic/comparison instruction setting the flag bits and copying the resulting flag vector. The inverse block performs the counterpart action and compares resulting flags with the vector from the operation block.

FIG. 5 illustrates how prototype structures of different types are interleaved in generating a Reversi test program. Given a database of functional blocks, the Reversi framework produces a set of stacks, consisting of blocks and inverse operations assembled in reverse order. Each stack operates on a single focus register, modifying it in such away that its final value matches the initial one. The stacks are then interleaved into a program with predictable outcome.

FIGS. 6a-6c illustrates a test program for a simple instruction set architecture (ISA) used as an example. The ISA only includes load, store, add, subtract, negate, branch-if-equal and halt instructions as presented in Table II below. FIG. 6a illustrates a stack with arithmetic/logic operations. FIG. 6b illustrates a stack with arithmetic operations, load/store pairs and forward taken branches. FIG. 6c illustrates an interleaving of atomic operations in the stacks of FIGS. 6a and 6b. and exit condition of the test.

FIG. 7 compares the total testing time for a traditional post-silicon flow against a Reversi-based flow for a system operating with the Alpha instruction set. The total time for the traditional post-silicon flow includes the test program generation, simulation and execution time. The time for the Reversi-based flow includes test generation and execution. For comparison, also plotted is the speed of a pre-silicon validation technique based on RTL simulation.

FIG. 8 compares the total testing time for a traditional post-silicon flow against a Reversi-based flow for a system operating with the x86 instruction set. The total time for the traditional post-silicon flow includes the test program generation, simulation and execution time. The time for the Reversi-based flow includes test generation and execution.

FIG. 9 is a plot of average time to discover bugs in a traditional post-silicon flow and in a Reversi-based flow. The experiments were run 10 times using different random seeds for the test generation on systems including a range of distinct design bugs. The minimum, average and maximum times to expose each bug are also plotted. Note that bugs loop, jsr and shbackbr could not be exposed by a traditional post-silicon flow based on a constrained-random test generator.

FIG. 10a illustrates a first example hardware set-up for establishing and executing a verification test on a prototype processor using an external verification device.

FIG. 10b illustrates a second example hardware setup for verification testing using the prototype processor to establish and execute the verification test.

While the disclosed methods and apparatus are applicable to embodiments in various forms, specific embodiments of the invention are illustrated in the drawings discussed hereafter. The disclosure is intended to be illustrative, and is not intended to limit the invention to the specific embodiments described and illustrated herein.

### DETAILED DESCRIPTION OF PREFERRED EMBODIMENTS

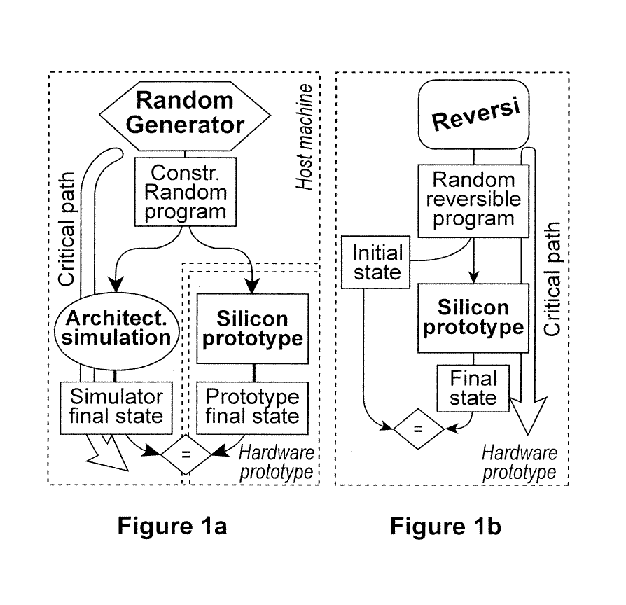

Typically, post-silicon functional validation in industry has been conducted with two types of tests: parameterized directed tests and constrained-random (or pseudo-random) tests. Although the former ones can provide high coverage, they require significant human effort to be developed. The pseudo-random tests, constrained to produce only valid instruction sequences, can be generated automatically; however, they often suffer from lower coverage. More importantly, the final state of the processor after executing a random test sequence is unknown. Therefore, engineers must resort to simulating the design's golden model to compute the final processor state and check it against state dumps of the actual hardware prototype, as illustrated in FIG. 1a.

In a typical post-silicon methodology, random tests are produced by a test generator and had to both a golden model simulator and a silicon prototype. Bugs are flagged by differences between the prototype's and simulator's final states. Both test generation and simulation are done on a host machine at relatively slow speed. See, for example FIG. 1b.

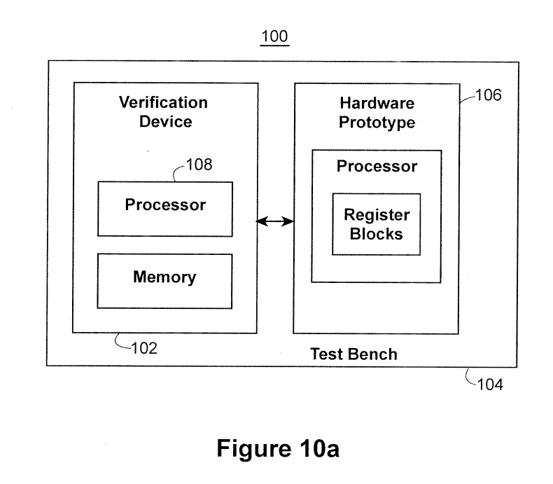

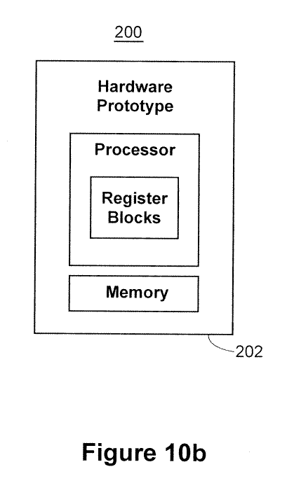

In contrast, the present application provides a high-throughput, post-silicon validation methodology that allows for test generation to match the performance of execution of the silicon prototype. This methodology is implemented through the Reversi test generation framework, which provides for post-silicon processor validation that exploits the full performance potential of silicon prototypes and eliminates the costly simulation step required to obtain a known-correct final state. The Reversi framework, for example, is able to generate tests in such a way that at the end of the execution, the initial state of the machine is restored. Therefore, a Reversi-based flow does not require a simulator: random reversible programs can be generated on a verification processor device, such as a tester board or the hardware prototype itself. See FIGS. 10a and 10b. Bugs are flagged by differences between final and initial states of the prototype. That is, the Reversi test generator framework produces tests whose outcome is known by construction. This allows one to bypass the simulation step and speed up the overall validation flow (FIG. 1.b).

One heuristic used in developing Reversi was the observation that many instructions in a processor's instruction set architecture (ISA) have counterparts, i.e., operations whose functionality is the inverse of the former, such as restoring a value in a particular register, clearing a set of flags, etc. Moreover, if no single instruction exists to reverse the action of another, one can devise a small program sequence to be used to the same effect. This was the case, for example, for the integer multiply instruction in one of the ISAs that used in the experimental evaluation of Reversi. No instruction for integer division was implemented, but we resorted to software emulation of division to revert the effect of multiplication. Note that, if the emulation routine exposed any error in the hardware prototype, the result of the multiplication would not be reversed correctly. The presence of inverse functions enabled us to design programs that include every instruction in an ISA, and for which the final register values match exactly the initial ones. In other terms, if x̅ is a vector representing the processor state, and each Fᵢ/Fᵢ⁻¹ pair represents a distinct function (either an ISA instruction or an instruction block) and the corresponding inverse, then a test program generated by Reversi could apply the following sequence of functions to the state x̅:

x=F₁⁻¹( . . . (Fₙ⁻¹( . . . (F₂(F₁(x))) . . . ))) . . . )) (1)

### Reversible and Non-reversible Instructions

In order to create reversible programs, we first analyzed each ISA and identified inverse instructions (or instruction sequences) for each of the operations. By applying these operations in the manner discussed, a test will able to modify the state of the processor and then properly restore it (in the absence of bugs) through the use of the inverse instructions. To facilitate this, a block database is created containing pairs of functional blocks, where for each operation block, there is a corresponding inverse block. Each block may contain either a single instruction or a small program sequence. An operation block modifies the value of a register, called the focus register, while its inverse restores its initial value. Along with generating the block database, the Reversi framework may set an ID for the focus register for each block. The Reversi sets the parameter dynamically during test generation. Therefore, the same block may appear in the test program multiple times, each time modifying a different register. This allows a varied set of programs to be created. Note that blocks operate only on a single focus register at a time to maintain the reversibility of our program and track the correctness of its execution. Thus, for instructions with multiple operands, only one of the registers is the focus register, while other operands are randomly generated by Reversi according to the instruction format. The flexible and robust structure of the block database allows the Reversi framework to be agnostic to the functionality of individual blocks and the underlying ISA, making the framework readily adaptable to different processor architectures. Moreover, since blocks in Reversi may contain multiple instructions, the framework can populate the database with complex functions, including loops, procedure calls, etc., and create elaborate tests representative of real software.

Some example individual classes of instructions and implementation details of operation and inverse block verifying them are now discussed.

Arithmetic and logic instructions. The design of blocks containing arithmetic and logic instructions is summarized in Table I and reflects that the majority of the operations already have an inverse directly in the ISA. For example, add can be reversed by sub, inc by dec, ror (rotate right) by rol (rotate left) and no on. If an instruction does not have a counterpart in the ISA, a small routine may be used to emulate its inverse. Some Boolean logic instructions, such as and or, do not have direct inverses. In some such cases, such operations can be used to construct another logic function that can be reversed, e.g., an xor logic function, which can then be reversed by an xor instruction. Such structure is also beneficial for verification of the xor instruction itself, since operation and inverse block in this case exercise different hardware modules. Preferably, situations where the same processor modules are used in the function and its inverse should be avoided to prevent bugs being masked by faulty hardware.

TABLE I

| Instruction | Operation Block | Inverse Block |
|---|---|---|
| add | add | sub |
| sub | sub | add |
| inc | inc | dec |
| dec | dec | inc |
| xor | xor | and/or emulated xor |
| not | not | nand emulated not |
| neg | neg | −1 mult emulated neg |
| and | and/or emulated xor | xor |
| or | and/or emulated xor | xor |
| mult | mult | emulated division |
| rol | rol | ror |
| ror | ror | rol |
| sll | store lost bits, sll | srl, restore lost bits |
| srl | store lost bits, srl | sll, restore lost bits |
| sra | 1. store lost bits, | 1. rol |
| | 2. create mask | 2. apply mask |
| | 3. sra | 3. restore lost bits |

Some ISA operations, for example sll and srl, cause some of the data bits to be lost. In order to be able to restore fully the initial value of the focus register, in some implementations, the Reversi framework is designed to mask out these bits and store them in the scratchpad memory before applying the operation. When the program reaches the inverse block, it first applies the reverse operation (i.e., shift in the opposite direction in this case) and then loads and restores the bits from memory. Finally, the outcome of an instruction may depend on the sign or value of the focus register, which is not known at generation time. For example, shift-arithmetic right (sra) will preserve the sign of the value by replicating its most significant bit. Blocks verifying such value-dependent operations can be built to execute differently based on the operand's value, saving and restoring all the bits required to deterministically retrieve the initial data.

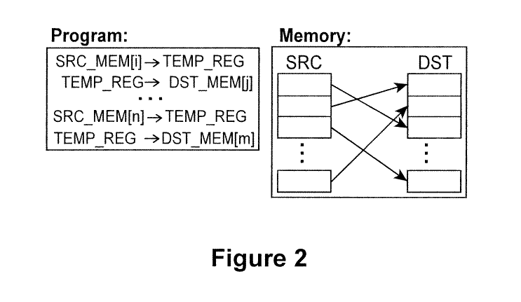

Load/store instructions. In Reversi, the correctness of load and store instructions is checked by copying a data structure, i.e., a region of memory is initialized with random values and load/store pairs are used to copy it to a new location. The Reversi framework does require that the copy preserves the order of the bytes, rather, the framework treat the data structure as a pool of values, which can appear out of order at destination (see FIG. 2). This allows test programs generated by the Reversi framework to closely resemble real software applications where loads bring data from memory to the processor, and stores copy results of the computation back. Moreover, because of their random nature. Reversi programs may contain a variety of cache and memory access patterns, that can expose corner-case bugs in the memory subsystem. To check the correctness of the final state of the memory, the Reversi framework compares an xor-hash of the memory values before and after test execution. This approach allows the Reversi framework to expose load/store related issues such as illegal memory accesses and/or data corruption.

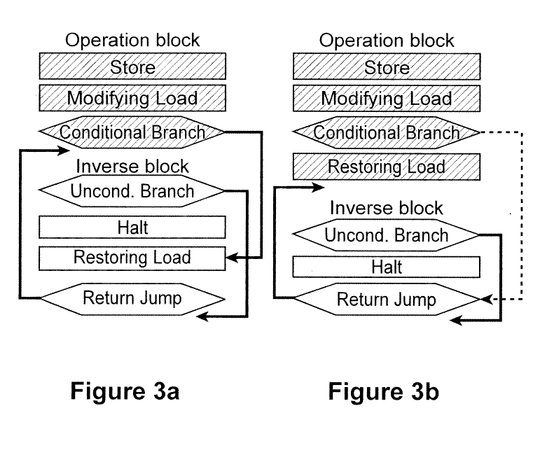

Branch instructions. The block database of the Reversi framework also contains templates that test branches with different properties: forward/backward, taken/nottaken etc. For example, an operation block for a forward taken branch (FIG. 3a) contains a store operation that saves the value of the focus register to scratchpad memory, followed by a load that overwrites the focus register with a predetermined constant and then by the branch itself. Although the constant is generated randomly, its value is dependent on the type of the tested branch. For example, a template for a beq (branch if equal) instruction, overwrites the focus register with a random constant and then loads a temporary register with the same value to test the branch.

With reference to FIG. 3a. the destination of the branch is located in the inverse block, which also contains a load operation restoring the focus register and a return jump. Therefore, if all control flow instructions are executed correctly, the value of the focus register after execution of the block is preserved. If, however, the branch is not taken by a faulty hardware, the focus register would not be restored. Note that the inverse block is only accessible via the proper branch and is skipped otherwise. If, however, the unconditional branch in FIG. 3 a is not taken due to a bug, the halt instruction is executed and the test stops without fully reverting processor's state. The structure of the blocks for forward not-taken branch (FIG. 3b) is similar to the one described above differing in the position of the restoring load. A similar technique is used to detect other faulty control flow operations, initializing all unused locations in the program to halt instructions.

Control register manipulation. In many modern processors there exist several special control registers. In general terms, we can classify them into two groups: mode control registers, that can only be accessed by special instructions and specify the machine's mode of operation; and Execution flag registers, that cannot be changed by the user but are affected indirectly by executed instructions. For instance, a register enabling/disabling the first level cache is a mode control register, while a register storing the ALU overflow bit or comparison bits from the comparator (equal, greater than, etc.) is an execution flag register.

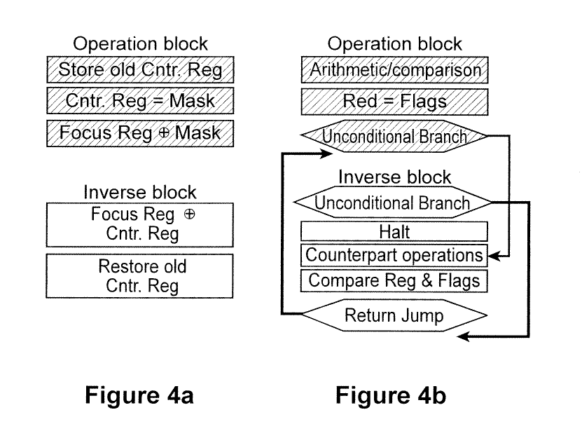

The Reversi framework is able to exploit the fact that the value of the mode control registers can be modified only through specific instructions, and must remain unchanged throughout other parts of program execution. To test the proper operation of a control register, the sequence of steps in FIG. 4a is taken. In the operation block, the old value of the control register is first stored to memory, then the new bit-mask is loaded to the control register and also xored with the focus register. In the inverse block, the Reversi framework first accesses the value of the control register and xors it with the focus register, restoring the previous mode of operation from memory afterwards. Thus, if the control register was erroneously modified between the execution of the operation and the inverse block, the focus register's value would reflect this error.

The Reversi framework can also check the correctness of execution flag registers, because instructions affecting them (arithmetic, logic and comparison) have counterparts in terms of which flags they set. For instance, if comp $rl, $r2 sets the greater-than bit, then comp $r2, $r1 must set the less-than bit. Similarly, knowing that a+b>c≡b>c−a, we can check that an add operation sets the overflow bit in the execution flag register correctly. In this case

add $rl, $r2, $r3 # overflow i.e. $r3>MAX

can be checked through subtraction and comparison:

sub MAX, $rl, $r3

comp $r2, $r3 # must set greater-than bit

where MAX is the largest number that can be stored in the register. Thus, individual bits of the flag register can be used to check other flag bits. The Reversi block structure for execution flag register validation is presented in FIG. 4b. The operation block executes a comparison or an arithmetic operation that affects the flags, stores the flags values in a register and jumps to the inverse block. The inverse block then executes the counterpart operations, obtains the resulting flags and checks if they correspond to previously computed ones. Recalling the example above, first the add executes in the operation block and then, in the inverse block. Reversi may check that if an overflow bit was net by the add, then a greater-than bit is set by the comp instruction.

Floating point instructions. Floating point operations present a unique challenge due to the their inherent imprecision. In the majority of cases the result of the computation is rounded, making it impossible to restore the operands exactly. To address this issue, we recognized this intrinsic approximation and took into account the relative error that is introduced by these operations. As a result, the Reversi framework constructs a table indexed by the exponents of the operands and checks the relative error after every operation against the expected boundaries. Although this solution will not lead to a strictly reversible program, the approach is still viable for floating point error detection.

As described, the Reversi framework can create high-coverage tests with a verifiable final state. Given the limits associated with certain of the heuristics discussed herein, the Reversi framework flexibility is such that it can be modified to address such factors. For example, the Reversi framework relies on the existence of inverse functions that can fully and precisely restore the internal state. In some examples, this may not be the case. For example, if the integer division operation was implemented in such a way that the remainder is lost, the value of the dividend could not be restored precisely. Similarly, floating point instructions do not exhibit such precision, however, they can still be partially verified by the approach described above. Also, input and output operations are inherently irreversible and cannot be easily covered. For example, external interrupts cannot be expected to arrive at a certain time and cannot be “undone” by the core. In addition, test programs may not target special execution cases for instructions whose output depends on the operands' values. For instance, a divide-by-0 operation may trigger an exception or set an error bit. Due to the randomness of operand values generated by Reversi, it is unlikely that a zero divisor occurs. Thus, to address any of these or other possibilities, the Reversi framework, and database in particular, can be augmented with specialized blocks to exercise unique instructions in such situations, including avoiding reversibility attempts altogether, as discussed herein and as will be appreciated upon reading this disclosure.

### Reversi Framework Generator

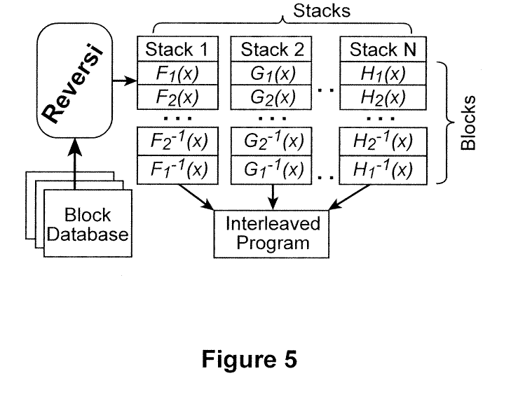

As described above, reversible programs generated by the Reversi framework consist of sequences of operation and inverse blocks instantiated from the block database. However, a single sequence of blocks only alters a single focus register, therefore, to create complex programs, the Reversi framework generates multiple block sequences (called stacks), each altering a different focus register. The stacks are then interleaved into a complex reversible test program, as illustrated in FIG. 5.

Stack generation. During the test generation, the Reversi framework randomly selects functional blocks from the database and creates a user-specified number of stacks, each consisting of several blocks and their inverses. Each stack has only one focus register selected at random. The blocks are then arranged so that inverse blocks follow operation blocks in inverse order (see Eq. 1). On a properly working processor the focus register should be restored to its original value once a stack execution completes. The Reversi framework also allocates a set of temporary registers to each of the stacks, based on the requirements of its blocks. In design, it was chose to allocate completely disjoint sets of registers to each stack to simplify the interleaving, although this need not be the case.

Stack interleaving. After the desired number of stacks is generated, the Reversi framework interleaves them by selecting instructions from all stacks and chaining them together to form a single test program. Note that some instructions may be grouped together into “atomic operations,” meaning that the interleaving phase cannot insert instructions between them. The atomicity indicator is provided in the block definition in the database. To balance the selection algorithm, we attribute different probabilities of selection to each stack, based on its length, so to avoid a long tail from a single stack at the end of the program. The probability of selecting the next instruction from a given stack j is:

$${P}_{j} = \frac{\vert {stack}_{j} \vert}{{\sum }_{i} \vert {stack}_{i} \vert}$$

where |stackⱼ| is the number of atomic operations in stackⱼ, and all Pⱼ's are adjusted after each removal of an atomic operation. Note that the requirements of using disjoint sets of registers in each stack may limit the total number of stacks in Reversi.

The test program includes one last routine that calculates the final xor-hash of the destination memory data structure. When the program terminates the final values of the focus registers and the hash of the destination memory are compared to the initial state computed by the Reversi framework during the generation to determine if the test executed successfully. It is also important to note that Reversi programs can provide more aid in debugging than traditional randomly generated programs. If the test results indicate that there is a bug in the processor, a validation engineer can quickly check if the exposing instruction sequence is located in an individual stack, by rerunning the program without interleaving. Insights into the nature of the bug can also be found by “peeling” operation and inverse blocks from the program. Therefore, a reversible program exposing a bug can be dramatically shortened to alleviate debugging. In contrast, in a traditional flow a costly re-simulation is required to obtain the new golden state after each change of the test program.

### Example

An example implementation is discussed below for a test program generated by the Reversi framework for a simple instruction set presented in Table II.

TABLE II

| Instruction | Semantics |
|---|---|
| halt | Stop the execution |
| add $r1, $r2, $r3 | $r3=$r1+$r2 |
| sub $r1, $r2, $r3 | $r3=$r1−$r2 |
| neg $r1, $r2 | $r2= −$r1 |
| ld $r1, var | $r1=MEM[var] |
| st $r1, var | MEM[var]=$r1 |
| beq $r1, $r2, label | PC=($r1==$r2) label : PC+1 |

Register $r0 is hardwired to the value 0

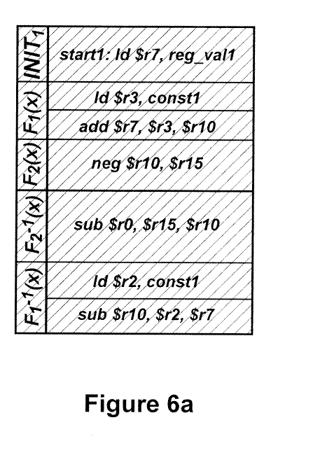

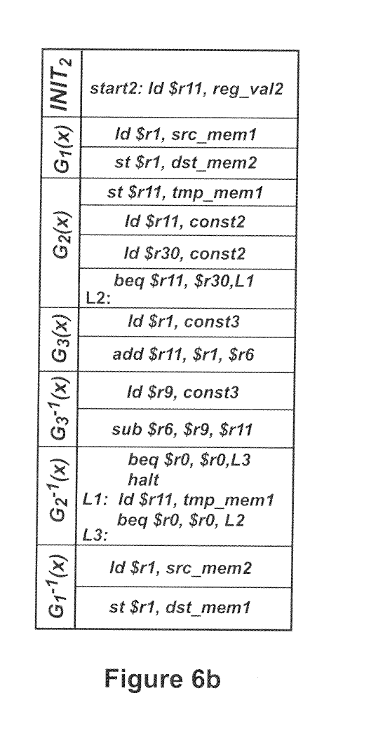

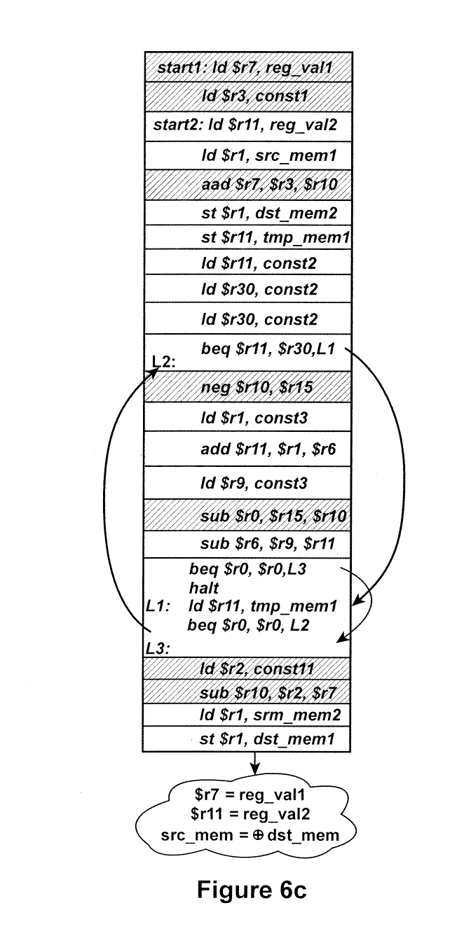

Two stacks for this ISA using focus registers $r7 and $r11 are shown in FIGS. 6a and 6b. For both stacks the function blocks are indicated in the left column and boxes mark atomic actions. The stack in FIG. 6a contains simple arithmetic/logic operations, while the stack in FIG. 6b includes logic instructions, load/store pairs and forward taken conditional branches. Sets of register IDs for both stacks are allocated dynamically by the Reversi framework and are disjointed. Initial focus register values (regval1 and regval2), constants (const1-const3) and location accessed by the loads and stores in the program are also selected at random.

An interleaving of the stacks into a program is shown in FIG. 6c. Conditions that must hold after this program executes are: $r7=reg_val1, $r11=reg_val2 and ⊕ src_mem=⊕ dst_mem. So, by using the resulting values of the focus registers $r7 and $r11 and the xor-hash of the dst_mem data structure, we can quickly determine if the program has exposed any functional bugs. Note also that the branch in block G₂ was generated by the Reversi framework to be taken. Thus, during correct operation, the execution should modify the value of $r11 and jump to the label L1. Then the processor restores the value of the focus register and takes the unconditional branch returning to L2. When operating properly, the processor should not visit line L1 again and skip directly to L3. Moreover, if the branch in G2 is not taken, then the exit condition described above does not hold, exposing a bug.

### Experimental Evaluation

Two Reversi setups were used to evaluate the experimental platform. We evaluated the performance of these setups against a traditional solution based on a constrained-random instruction sequence generator. We also investigated the bug-finding capabilities of Reversi.

### Experimental Framework

To evaluate the performance of the Reversi approach, we created two reversible instruction block databases: one implementing a subset of the Alpha instruction set and another implementing a subset of the x86 ISA. The database for the Alpha instruction set contained 17 distinct blocks for arithmetic and logic functions testing a range of instruction formats (reg/reg and reg/imm) and 5 blocks for each type of compare instructions. In addition to that, the database included 3 blocks for load and store instructions, an unconditional jump block and 16 branch blocks containing 4 distinct branching instructions, each in four possible modes (fw/bw and taken/nottaken). Similarly, the x86 block database contained 32 logic-arithmetic blocks testing multiple instruction formats (reg/reg, reg/imm, reg/mem, mem/reg), 3 load-store blocks, 1 compare block and 40 branch blocks. The Reversi framework was implemented as an optimized program in C that created and interleaved a specified number of stacks and contained routines to set a random initial state and perform the final check. The blocks were partially pre-assembled in binary, and Reversi was responsible for setting the appropriate bit-fields with register IDs, randomly generated constants, etc.

To compare the Reversi program with a traditional post-silicon validation flow (FIG. 1.a), we created an assembly-level constrained-random test generator. In addition, for the architectural simulation phase of the traditional post-silicon flow, we used M5 2.0b3 (the M5 simulator system, November 2007. http://www.m5sim.org.) and Bochs-2.3.5 (the open source IA-32 emulation project. September 2007. http://bochs. sourceforge. net/.) for Alpha and x86 systems, respectively. Test generation and simulation for both Reversi and the traditional post-silicon flow was performed on a 3.2 GHz Pentium 4 machine with 2 GB of memory.

### Performance Evaluation

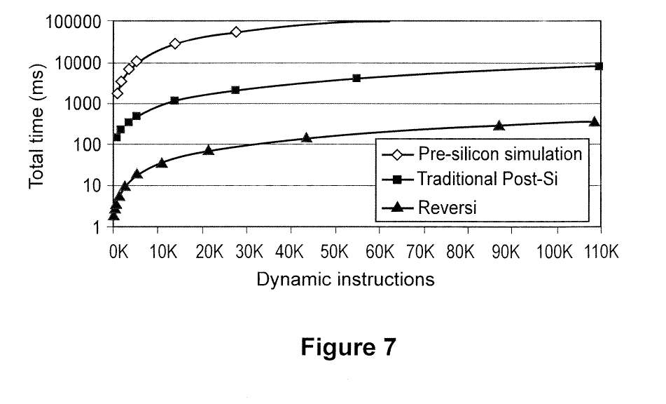

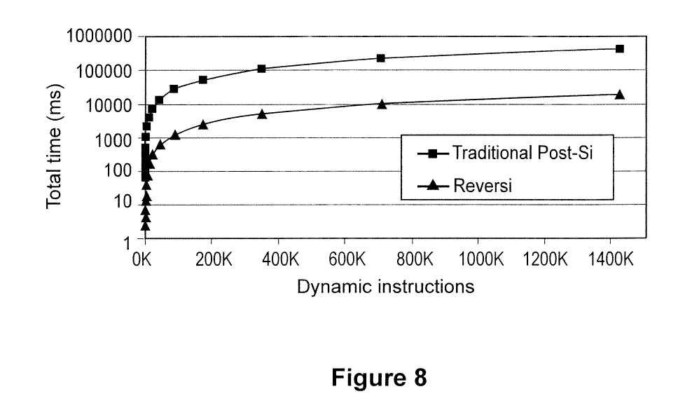

In the first experiment, we compared the validation performance of the traditional post-silicon flow with the Reversi flow. In this case the total time for the traditional flow consisted of i) the time to create a program on the constrained-random test generation, ii) the time for the instruction set simulator (either M5 or Bochs) to obtain the golden state and iii) the execution time on the silicon prototype. For the Reversi flow we included i) the Reversi generation time and ii) the time to execute on silicon. Performance for the Alpha design was measured over shorter program sequences, while x86 used longer testing programs. The results of the experiments are presented in FIGS. 7 and 8. FIG. 7 also plots the performance of a typical pre-silicon simulator (using a behavioral Verilog model of the Alpha design) for comparison. As these figures demonstrate, the Reversi based approach flow provides a 19.5 times and 21.5 times performance improvement for Alpha and x86 designs, respectively. It should be noted that in addition to eliminating the simulation step from the flow. Reversi is more efficient because it operates on pre-assembled blocks. In a traditional approach, on the other hand, the generator must frequently solve fairly complex constraints to produce valid and meaningful tests.

Moreover, due to the presence of branching instructions and PC-relative branches, the program generator must produce tests in assembly language and then call an assembler to convert it to machine codes. The Reversi technique, however, does not need an external assembler, since it implements internally all functions required to generate the binary code.

### Design Error Coverage

In the second experiment, we use an RTL implementation of a 5-stage pipeline running Alpha ISA to create 20 designs, each containing a single bug from Table III.

TABLE III
Bugs introduced in Alpha design

| Bug | Description |
|---|---|
| ldstaddr | load to store address forwarding fault |
| regfilerd | faulty internal forwarding in register file read port A |
| fwdmem | error in forwarding dependency resolution |
| fwdreg31 | forwarding through register 31 (const 0) |
| ucbrcbr | unconditional branch after conditional branch fails |
| fwdwb | unnecessary forwarding from wb stage |
| regfilewr | invalid write access to register file |
| flush | pipeline flush on specific register file access |
| srl | invalid execution of logical right shift |
| scmpcbr | invalid forwarding from signed compare to a branch |
| cbrst | backward conditional branch after a store is not taken |
| ldstdata | load to store data forwarding fault |
| ucmpcbr | invalid forwarding from unsigned compare to a branch |
| backcbr | specific backward conditional branch is never taken |
| addover | incorrect handling of overflow on add |
| loop | incorrect execution of looping sequence |
| jsr | incorrect handling of jsr with invalid address |
| backucbr | fault in backward unconditional branch |
| shbackbr | fault in branch resolution for short backward branch |
| ldarith | invalid execution of a load followed by arithmetic |

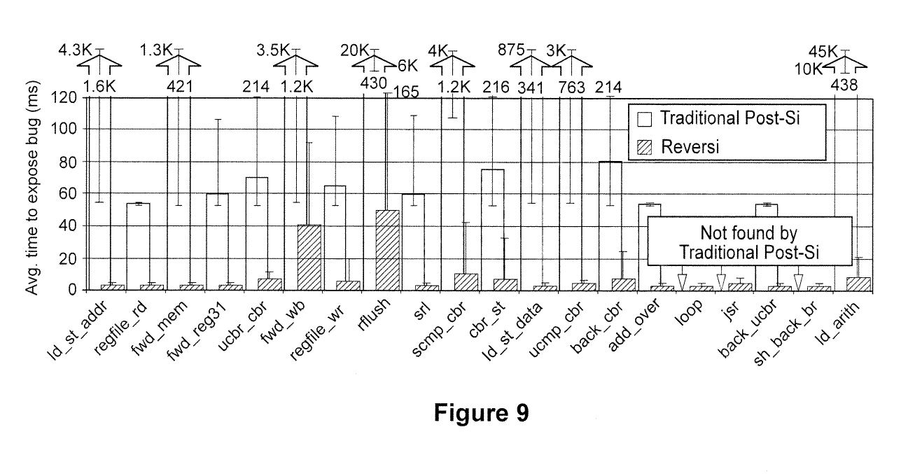

During the test, both the traditional flow and Reversi generated code of increasing length until the bug was exposed. Note that, in order to identify an error with a randomly generated program, we first computed the correct final state by running it on a known-correct model. We ran the experiment 10 times with different random seeds and calculated the minimum, average and maximum time required for the traditional flow and Reversi to expose the fault (FIG. 9).

As the results in FIG. 9 demonstrate, Reversi can find all errors faster than the traditional post-silicon flow, and by orders of magnitude in some instances. Furthermore, some of the bugs, such as loop, jsr and shbackbr, were not exposed by the post-silicon flow in any of the runs. We believe that this was due to the unique nature of the programs generated by the Reversi framework—they are designed so that only correctly operating hardware produces an easily verifiable result. Thus, incorrect operations can be detected immediately at execution completion. Moreover. Reversi creates complex programs with multiple interleaved execution flows that exercise all instructions in the ISA, exposing these corner-case bugs.

It's worth observing that, in several experiments with the traditional flow (such as fw_wb), a shorter random program exposed a bug, while a longer sequence of instructions did not. This is possibly due to the random nature of the test: later instructions may overwrite registers/memory locations that contain incorrect values, thus eliminating the evidence of the bug. Therefore, a longer random program does not necessarily find more bugs than a shorter one. Reversi programs, on the other hand, are designed so that any behavior corrupting the processor state is propagated to the exit point and exposed.

Thus, a novel post-silicon validation methodology is provided that exploits the performance potential of hardware prototypes and bypasses the design simulation step required by traditional flows. Test programs that the Reversi framework generates work to explore complex execution scenarios and, most importantly, have identical initial and final architectural states eliminating the need for a simulator to check the correctness of the test. The programs are built from sequences of functional blocks, which modify the state of the machine, and they are combined with inverse blocks to undo earlier operations and restore the original machine state. Individual blocks are parameterized and may consist of one or several instructions, selected randomly from a block database during test generation. Reversi handles all types of instructions: arithmetic (integer and floating point), logic, memory accesses, control flow and control register operations. As our results demonstrate, Reversi creates programs capable of finding more bugs faster than traditional constrained-random test generation techniques. Moreover, due to the omission of the architectural simulation step, the Reversi framework can generate and run tests 20 times faster than tools based on a traditional post-silicon flow.

FIG. 10a illustrates an example hardware set up 100 for developing and executing a verification test in accordance with an example herein. A verification processor device 102 is on a test bench 104 with the test (e.g., hardware prototype) processor 106. The device 102 identifies initial and inverse instructions of the ISA of the test processor 106. The device 102, which includes a processor 108, a memory 110, generates a verification test comprising one or more stacks, each assigned to alter a register on the processor and each may be assigned to a different operations pairing. The verification test may then be executed on the test processor 106 with the test results provided back to and analyzed by the verification device 102.

FIG. 10b is similar to FIG. 10a except that hardware set up 200 uses a test processor 202, e.g., the hardware prototype, to develop a verification test, similar to that of device 102 in FIG. 10b, and then execute that verification test on device 202. Thus, the Reversi framework may be used in a test bench environment with different processors or on the same processor to be tested for verification.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A method of developing an executable verification test for examining a test processor capable of executing stored instructions, the method comprising:
a verification processor device identifying one or more initial operations from one or more instructions of the instruction set architecture (ISA) of the test processor;
the verification processor device determining one or more inverse operations, each corresponding to one of the initial operations; and
the verification processor device generating the verification test comprising one or more stacks, wherein each stack is assigned to alter a register on the test processor, and each stack is assigned to a different pair of initial operations and inverse operations, wherein if there are a plurality of stacks the stacks are interleaved with each other, further whereby each stacks applies its initial operation to its register and then applies its inverse operation in the reverse order to its register, wherein the application of the inverse operation returns the register to a state before application of the initial operation of the stack.

2. The method of claim 1, wherein the initial operation is an instruction in the ISA of the test processor.

3. The method of claim 2, wherein the inverse operation is an instruction in the ISA of the test processor.

4. The method of claim 2, wherein the inverse operation comprises a plurality of instructions in the ISA of the test processor, wherein those the plurality of instructions operate to reverse an effect created by the initial operation.

5. The method of claim 1, wherein the initial operation comprises a plurality of instructions in the ISA of the test processor that are to be executed together.

6. The method of claim 1, wherein generating the verification test comprises:
generating a plurality of stacks, each stack assigned to a different pair of initial operations and inverse operations, each stack assigned to a different register; and
interleaving the plurality of stacks to form the verification test.

7. The method of claim 6, wherein each initial operation corresponds to a different one of instructions in the ISA of the test processor, and there are a sufficient number of initial operations such that each instruction in the ISA has a corresponding initial operation.

8. The method of claim 6, further comprising grouping a subset of the plurality of stacks such that instructions cannot be interleaved into the subset.

9. The method of claim 1, wherein at least one of the initial operations comprises at least one arithmetic instruction in the ISA of the test processor.

10. The method of claim 1, wherein at least one of the initial operations comprises at least one logic instruction in the ISA of the test processor.

11. The method of claim 1, wherein at least one of the initial operations comprises at least one a load or store instruction in the ISA of the test processor.

12. The method of claim 1, wherein at least one of the initial operations comprises at least one branch instruction in the ISA of the test processor.

13. The method of claim 1, wherein at least one of the initial operations comprises at least one floating point instruction in the ISA of the test processor.

14. The method of claim 1, wherein the initial operation is an instruction in the ISA of the test processor that changes a state of a control register from an initial state to a manipulated state.

15. The method of claim 14, wherein inverse operation changes the state of the control register from the manipulated state to the initial state.

16. The method of claim 1, wherein the verification processor device is a separate processor device than the test processor and coupled thereto.

17. The method of claim 1, wherein the verification processor device is the test processor.
